(19) United States
(12) Patent Application Publication
(10) Pub. No.: US 2011/0187603 A1
(43) Pub. Date: Aug. 4, 2011

(54) DIELECTRIC ANTENNA AND WIRELESS COMMUNICATION DEVICE

(75) Inventors: Kunihiro KOMAKI, Kyoto-fu (JP); Masayuki ATOKAWA, Kyoto-fu (JP); Masahiro IZAWA, Kyoto-fu (JP); Tsuyoshi MUKAI, Kyoto-fu (JP)

(73) Assignee: MURATA MANUFACTURING CO., LTD., Kyoto-fu (JP)

(21) Appl. No.: 13/020,439

(22) Filed: Feb. 3, 2011

(30) Foreign Application Priority Data
Feb. 4, 2010 (JP) 2010-022724

(51) Int. Cl. H01Q 1/38

(52) U.S. Cl. 343/700 MS

(57) ABSTRACT

A dielectric antenna and wireless communication device including the dielectric antenna includes a molded body formed of a composite material of dielectric ceramic and a resin, and a flexible substrate including a radiation electrode. The radiation electrode is excitable at frequencies of 500 MHz to 5 MHz. The composition ratio and the like of the molded body are determined so that the Q value (Qd) thereof due to dielectric loss falls within the range of about 500 to about 1500.

### CROSS REFERENCE TO RELATED APPLICATIONS

The present application claims priority to Japanese Patent Application No. 2010-022724 filed Feb. 4, 2010, the entire contents of which are incorporated herein by reference in their entirety.

### FIELD OF THE INVENTION

The present invention relates to a dielectric antenna for use in a wireless communication device, such as a mobile phone terminal, and a wireless communication device including the dielectric antenna.

### BACKGROUND

Japanese Unexamined Patent Application Publication No. 2008-193299 discloses an antenna that includes: a flexible substrate including a circuit for an inverted-F antenna; and a dielectric interposed between a ground unit and a radiation element unit that are formed by folding the flexible substrate substantially in the form of U and that are flat and opposed to each other.

FIG. 1 is a development view of the inverted-F antenna according to Japanese Unexamined Patent Application Publication No. 2008-193299. The inverted-F antenna includes: a flexible substrate 3 including a circuit 2 for an inverted-F antenna; and a dielectric interposed between a ground unit 3a and a radiation element unit 3b that are formed by folding the flexible substrate 3 substantially in the form of U and that are flat and opposed to each other.

Japanese Unexamined Patent Application Publication No. 2008-193299 discloses that a lower dielectric loss (tan δ) gives a higher gain. However, the amount of gain depends on the frequency band of the antenna in use, and the like. Even a lower tan δ (hereafter referred to as “a higher Qd”) may not cause a significant gain increase (hereafter referred to as “efficiency”).

Generally, a material having a higher Qd at frequencies of about 500 MHz to about 5 GHz, which are used in mobile wireless communications, is more costly. Thus, consideration must also be given to the cost varying with the amount of improvement in characteristics.

Moreover, the reflection characteristics of an antenna can be influenced by values other the Qd. Thus, it is possible that by increasing Qd, the reflection characteristics degrade. In such a case, the matching between the antenna and the circuit connected to the antenna would be degraded and the reflected power would be increased. This can adversely affect other circuits.

For this reason, a higher Qd cannot always be said to totally improve the characteristics of the antenna, including cost.

### SUMMARY

The invention is directed to a dielectric antenna that can make a significant amount of improvement in efficiency, as well as in the reflection and attenuation characteristics, and a wireless communication device including the dielectric antenna.

A dielectric antenna consistent with a claimed invention includes a molded body formed of a composite material of dielectric ceramic and a resin, and a flexible substrate including a radiation electrode that is overlaid on the molded body. The radiation electrode is excitable at frequencies of 500 MHz to 5 GHz, and a Qd value of the composite material due to dielectric loss falls within the range of 500 to 1500.

In a more specific exemplary embodiment consistent with the claimed invention, a Qd value due to dielectric loss of an adhesive or cement for bonding the flexible substrate to the molded body may fall with the range of 10 to 100.

In another more specific exemplary embodiment consistent with the claimed invention, the radiation electrode may be multiple linear conductors branching from a feeding portion of the flexible substrate or the vicinity of the feeding portion.

In yet another more specific embodiment consistent with the claimed invention, the flexible substrate may be a substrate where linear conductors are formed on a PET film. The linear conductors may branch from a branching portion of the flexible substrate adjacent to a feeding portion thereof and extend to openings in parallel with each other.

A wireless communication device consistent with the claimed invention includes the dielectric antenna according to any of the above embodiments and a cabinet containing the dielectric antenna.

Other features, elements, characteristics and advantages of the present invention will become more apparent from the following detailed description of preferred embodiments of the present invention with reference to the attached drawings.

### BRIEF DESCRIPTION OF THE DRAWINGS

FIG. 1 is a development view of an inverted-F antenna according to Japanese Unexamined Patent Application Publication No. 2008-193299.

FIG. 2 is a perspective view of the main part of a dielectric antenna according to a first exemplary embodiment.

FIG. 3 is a graph showing the relationship between a design goal of the antenna, efficiency (design goal η), and a required Qd value.

FIG. 4 is a sectional view showing the configuration of a wireless communication device according to a second exemplary embodiment.

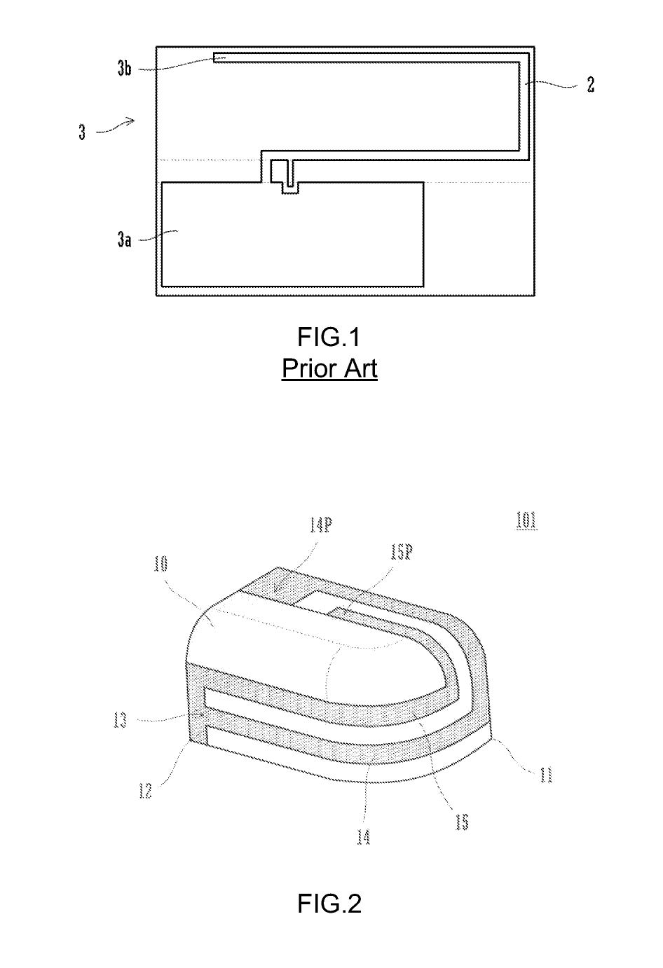

### DETAILED DESCRIPTION

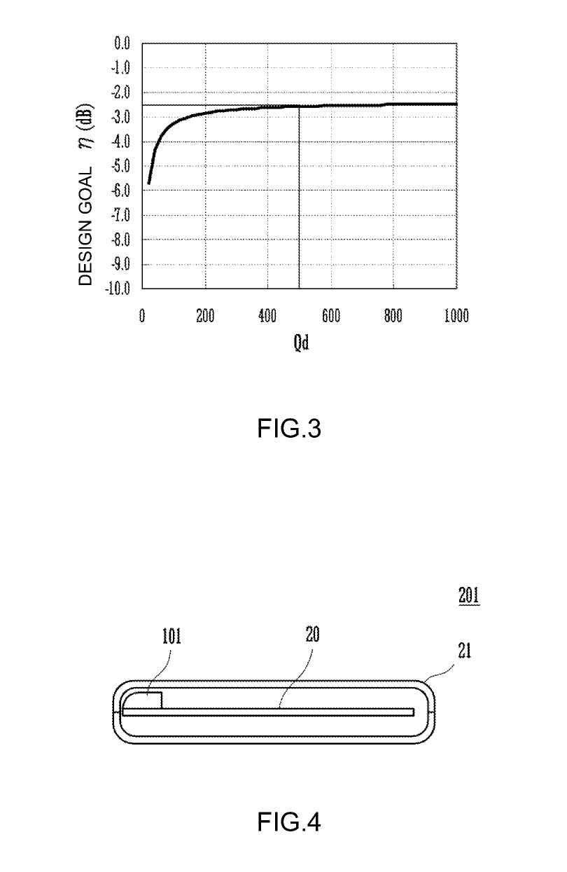

The configuration and characteristics of a dielectric antenna according to a first exemplary embodiment will be described with reference to FIGS. 2 and 3.

FIG. 2 is a perspective view of the main part of a dielectric antenna 101 according to a first embodiment of the present invention. The dielectric antenna 101 includes a molded body 10 formed of a composite material of dielectric ceramic and a resin, and a flexible substrate 11 including radiation electrodes.

The molded body 10 is, for example, a composite of ceramic powder containing at least one of calcium titanate, rutile titanium oxide, anatase titanium oxide, alumina, calcium carbonate, and strontium titanate and a liquid crystal polymer (2-hydroxy-6-naphthoic acid, hydroquinone, 2,6-naphthalene dicarboxylate, terephthalic acid). The composition ratio and the like of the molded body 10 are determined so that the Q value (Qd) thereof due to dielectric loss falls within the range of about 500 to about 1500.

The flexible substrate 11 can be a substrate where linear conductors 14 and 15 and the like are formed on a PET film. The linear conductors 14 and 15 branch from a branching portion 13 of the flexible substrate 11 adjacent to a feeding portion 12 thereof and extend to openings 14p and 15p in parallel with each other. The two linear conductors, 14 and 15, have different lengths. The longer linear conductor 14 is excited at low frequencies, while the shorter linear conductor 15 is excited at high frequencies.

The above-mentioned PET film can have a Qd of about 50 to about 200.

The molded body 10 takes the shape of a rectangular parallelepiped whose adjacent three faces have rounded edges. As can be seen from FIG. 2, the flexible substrate 11 can take the shape of L when it is developed, and can be bonded to the faces of the molded body 10 using an adhesive or cement. The Qd value of this adhesive or cement can range from 10 to 100.

The two linear conductors, 14 and 15, which branch from the vicinity of the feeding portion 12, serve as radiation electrodes and are excited or excitable at frequencies of about 500 MHz to about 5 GHz.

FIG. 3 is a graph showing the relationship between a design goal of the antenna, efficiency (design goal or target η), and the required Qd value. The design goal η is a value obtained from the required peak efficiency value and the required bandwidth. A theoretical equation for obtaining the design target η is as follows. The peak efficiency value in the equation refers to the maximum average efficiency value in any frequency band, of the antenna to be designed.

Design goal η=x×peak efficiency value×fo/BW

As seen, the design parameter “design goal η” is obtained from the peak efficiency value, the center frequency fo, the bandwidth BW, and the constant x determined by the antenna to be designed. This parameter is used to set the efficiency value within the required bandwidth in designing the antenna.

“The required peak efficiency value” and “the required bandwidth” are also design parameters. Since the required Qd value is determined based on the relationship between these two design parameters, “the design goal η” is set as a parameter representing the relationship between the two design values.

In the relationship shown in FIG. 3, after the Qd exceeds about 500, the design goal η does not change much even when the Qd is increased, although the relationship varies depending on the structure of the antenna. In the shown relationship, the design goal η can be said to hardly change when the Qd becomes about 1500, considering an allowance.

It is unrealistic to manufacture an antenna having a Qd of 1500 or more in terms of the availability of the material. Moreover, even when the Qd is increased to 1500 or more, no significant improvement in characteristics can be seen. Accordingly, 1500 is set as the upper limit of the Qd.

Since the adhesive (e.g., double-faced tape) or cement for bonding the flexible substrate 11 to the molded body 10 is adjacent to the linear conductors of the flexible substrate, the adhesive or cement is preferably formed of a material having a high Qd. However, the adhesive or cement is difficult to form using a high-Qd material. Because the thickness of the adhesive or cement can be reduced, the Qd of the molded body 10 has a dominant influence over the design goal η compared with those of the other elements. For this reason, the Qd value of the adhesive or cement preferably falls within the range of about 10 to about 100. This range is determined based on the Qd of realistically selectable materials.

While, in the above-mentioned example, the two linear conductors, 14 and 15, are provided on the flexible substrate 11, three or more linear conductors can be provided.

FIG. 4 is a sectional view showing the configuration of a wireless communication device 201 according to a second embodiment of the present invention. The wireless communication device 201 is a wireless communication device in which a circuit substrate 20 having the dielectric antenna 101 shown in the first embodiment mounted thereon is contained in a cabinet 21. The wireless communication device 201 is, for example, a mobile phone terminal. A wireless communication circuit for performing wireless communications using the dielectric antenna 101, and other circuits are formed on the circuit substrate 20.

The dielectric antenna 101 is disposed in the cabinet 21 in such a manner that a rounded surface of the dielectric antenna 101 is along the inner surface of the cabinet 21, that is, in such a manner that the dielectric antenna is adjacent to the cabinet. For this reason, the cabinet 21 also preferably has a high Qd. Note that since the cabinet 21 is away from the linear conductors of the flexible substrate somewhat, it is important to set the Qd of the molded body (the molded body 10 shown in FIG. 2) whose Qd has a dominant influence, within the above-mentioned range.

Embodiments consistent with the invention set or fix the lower limit of the Q value (Qd) of the composite material due to dielectric loss. Thus, required efficiency, as well as required reflection and attenuation characteristics can be satisfied. Further, the upper limit of the Qd is set or fixed. This can prevent degradation of the reflection and attenuation characteristics due to too high a Qd.

Thus, advantageously, an improvement in efficiency, as well as in the reflection and attenuation characteristics can be made.

In some embodiments, a limit is also imposed on the Q value (Qd) due to dielectric loss of the adhesive or cement for bonding the flexible substrate to the molded body. Thus, a further improvement can be made.

Because multiple linear conductors branching from the feeding portion or its vicinity can be used as the radiation electrode, a high-efficiency characteristic can be obtained in a wide frequency band of about 500 MHz to about 5 GHz.

While preferred embodiments of the invention have been described above, it is to be understood that variations and modifications will be apparent to those skilled in the art without departing from the scope and spirit of the invention. The scope of the invention, therefore, is to be determined solely by the following claims.

What is claimed is:

1. A dielectric antenna comprising:
a molded body formed of a composite material of dielectric ceramic and a resin; and
a flexible substrate that is overlaid on the molded body and comprised of a radiation electrode, wherein
the radiation electrode is excitable at frequencies of 500 MHz to 5 GHz, and
a Qd value of the composite material due to dielectric loss falls within the range of 500 to 1500.

2. The dielectric antenna according to claim 1, wherein
a Qd value due to dielectric loss of an adhesive or cement for bonding the flexible substrate to the molded body falls within the range of 10 to 100.

3. The dielectric antenna according to claim 1, wherein
the radiation electrode is a plurality of linear conductors branching from a feeding portion of the flexible substrate or the vicinity of the feeding portion.

4. The dielectric antenna according to claim 2, wherein
the radiation electrode is a plurality of linear conductors branching from a feeding portion of the flexible substrate or the vicinity of the feeding portion.

5. The dielectric antenna according to claim 1, wherein the flexible substrate is a substrate where linear conductors are formed on a PET film.

6. The dielectric antenna according to claim 5, wherein the linear conductors branch from a branching portion of the flexible substrate adjacent to a feeding portion thereof and extend to openings in parallel with each other.

7. A wireless communication device comprising: the dielectric antenna according to claim 1; and
a cabinet containing the dielectric antenna.

8. A wireless communication device comprising: the dielectric antenna according to claim 2; and
a cabinet containing the dielectric antenna.

9. A wireless communication device comprising: the dielectric antenna according to claim 3; and
a cabinet containing the dielectric antenna.

10. A wireless communication device comprising: the dielectric antenna according to claim 4; and
a cabinet containing the dielectric antenna.

11. A wireless communication device comprising: the dielectric antenna according to claim 5; and
a cabinet containing the dielectric antenna.

12. A wireless communication device comprising: the dielectric antenna according to claim 6; and
a cabinet containing the dielectric antenna.
